(19) United States
(12) Patent Application Publication
(10) Pub. No.: US 2025/0362387 A1
(43) Pub. Date: Nov. 27, 2025

(54) SENSOR COVER

(71) Applicants: HYUNDAI MOTOR COMPANY, SEOUL (KR); KIA CORPORATION, SEOUL (KR); ECOPLASTIC CORPORATION, GYEONGJU-SI (KR)

(72) Inventors: Hong Heui Lee, Hwaseong-si (KR); Dong Ha Kim, Hwaseong-si (KR); Jin Young Yoon, Hwaseong-si (KR); Seon Young An, Hwaseong-si (KR); Tai Won Kim, Gyeongju-si (KR); Wan Ho Son, Gunpo-si (KR); Eung Joo Kim, Gyeongju-si (KR)

(73) Assignees: HYUNDAI MOTOR COMPANY, SEOUL (KR); KIA CORPORATION, SEOUL (KR); ECOPLASTIC CORPORATION, GYEONGJU-SI (KR)

(21) Appl. No.: 18/926,035

(22) Filed: Oct. 24, 2024

(30) Foreign Application Priority Data
May 23, 2024 (KR) 10-2024-0066980

(51) Int. Cl. G01S 7/481; G01S 7/497; G01S 13/86; G01S 17/86; G01S 17/931

(52) U.S. Cl. CPC G01S 7/4813; G01S 7/4815; G01S 7/497; G01S 13/865; G01S 17/86; G01S 17/931

(57) ABSTRACT

A front surface structure of an electric vehicle includes a sensor cover configured to transmit detection signals of different environmental sensors, and includes a plurality of sensing regions provided for each of the different environmental sensors. The sensor cover may protect the environmental sensors of the vehicle without hindering the transmission performance of the environmental sensors.

### CROSS REFERENCE TO RELATED APPLICATIONS

This application claims under 35 U.S.C. § 119 (a) the benefit of priority to Korean Patent Application No. 10-2024-0066980 filed on May 23, 2024, the entire contents of which are incorporated herein by reference.

### TECHNICAL FIELD

The present disclosure relates to a structure of an electric vehicle. More particularly, it relates to a front surface structure of an electric vehicle.

### BACKGROUND

Electric vehicles are driven by a motor powered by a rechargeable battery. Particularly, due to eco-friendly characteristics of electric vehicles, active research and development on electric vehicles has been recently conducted.

Internal combustion engine vehicles are equipped with a radiator grill on the front face of the vehicle. The radiator grill may allow air to flow into an engine compartment to cool an engine and may protect a radiator.

Recently, the traditional role of the radiator grill is weakening with the change from internal combustion engine vehicles to electric vehicles, and changes in the front face of the vehicle equipped with the radiator grill are desired in terms of functionality and design.

The above information disclosed in this Background section is only for enhancement of understanding of the background of the disclosure and therefore it may contain information that does not form the prior art that is already known to a person of ordinary skill in the art.

### SUMMARY

The present disclosure has been made in an effort to solve the above-described problems associated with the prior art, and it is an object of the present disclosure to provide a sensor cover which may protect environmental sensors of a vehicle.

It is another object of the present disclosure to provide a sensor cover which does not hinder the transmission performance of environmental sensors.

It is yet another object of the present disclosure to provide a sensor cover which may improve aesthetics.

It is a further object of the present disclosure to provide a sensor cover which may prevent deterioration of the functions of environmental sensors even when the external environment worsens.

The objects of the present disclosure are not limited to the above-mentioned objects, and other objects not mentioned herein will be clearly understood by one having ordinary skill in the art to which the present disclosure pertains from the following description.

In order to achieve the objects of the present disclosure, as described above, and perform characteristic functions of the present disclosure, which will be described later, features of the present disclosure as follows.

In one aspect, the present disclosure provides a sensor cover configured to transmit detection signals of different environmental sensors and including a plurality of sensing regions provided for each of the different environmental sensors.

Other aspects and preferred embodiments of the disclosure are discussed infra.

### BRIEF DESCRIPTION OF THE FIGURES

The above and other features of the present disclosure will now be described in detail with reference to embodiments thereof illustrated in the accompanying drawings which are given hereinbelow by way of illustration only, and thus are not limitative of the present disclosure, and wherein:

FIG. 1 is a view showing an example arrangement of environmental sensors provided on the front face of a vehicle;

FIG. 2 is a schematic configuration diagram of a sensor cover according to one embodiment of the present disclosure;

FIG. 3 is an exploded perspective view of the sensor cover according to one embodiment of the present disclosure;

FIG. 4 is a view schematically showing the sensor cover according to one embodiment of the present disclosure;

FIG. 5 is a cross-sectional view taken along line A-A of FIG. 4;

FIG. 6 is an enlarged view of a circular portion shown in a dotted line of FIG. 5;

FIG. 7 is a cross-sectional view taken along line B-B of FIG. 4;

FIG. 8 is an enlarged view of region R1 of FIG. 7;

FIGS. 9 and 10 are views showing a heating wire film of the sensor cover according to one embodiment of the present disclosure;

FIG. 11 is a view showing a process of installing the heating wire film in the sensor cover according to one embodiment of the present disclosure;

FIG. 12 is a perspective view of a lighting film of the sensor cover according to one embodiment of the present disclosure;

FIGS. 13A and 13B are views showing a method of forming a pattern structure of a lighting film according to one embodiment of the present disclosure;

FIGS. 14A and 14B are views showing a method of forming a pattern structure of a lighting film according to another embodiment of the present disclosure;

FIG. 15 is a view illustrating a process of forming indirect lighting by light provided by light emitting diodes (LEDs) for the lighting film according to one embodiment of the present disclosure;

FIG. 16 is a view showing an example operating scenario of the lighting film according to one embodiment of the present disclosure;

FIG. 17 is a view showing an example operating scenario of an LED module according to one embodiment of the present disclosure;

FIG. 18 is a cross-sectional view taken along line C-C of FIG. 4;

FIG. 19 is a control flowchart of the heating wire film of the sensor cover according to one embodiment of the present disclosure;

FIG. 20 is a control flowchart of the heating wire film of the sensor cover according to one embodiment of the present disclosure; and

FIG. 21 is a control flowchart of the heating wire film of the sensor cover according to one embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Specific structural or functional descriptions in embodiments of the present disclosure set forth in the description which follows will be exemplarily given to describe the embodiments of the present disclosure, and the present disclosure may be embodied in different forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, the present disclosure will be described in detail with reference to the accompanying drawings.

Vehicles have been recently equipped with a driver assistance system that assists the driver of the vehicle to ensure safe driving. In addition to the driver assistance systems, autonomous vehicles that may drive on their own without driver intervention have emerged.

In such a vehicle equipped with the driver assistance system or an autonomous vehicle, environmental sensors, such as a radar, a LiDAR, and a camera that may sense the surrounding environment in various ways, are installed in the vehicle. These environmental sensors are installed throughout the vehicle, including the front and rear parts, roof, and sides of the vehicle.

In internal combustion engine vehicles, several environmental sensors may also be installed on the front face of the vehicle where a radiator grill is located. Further, as described above, in electric vehicles, changes in the role of the radiator grill are required.

Accordingly, the present disclosure aims to provide a sensor cover that enables changes in the functional and design aspects of the front surface of a vehicle in place of a radiator grill.

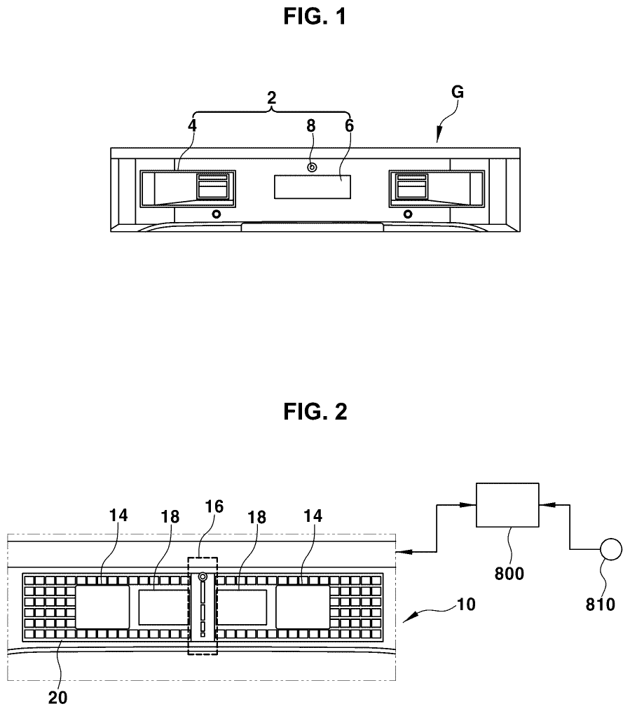

As shown in FIG. 1, one or more environmental sensors 2 may be mounted on a radiator grill area G in an electric vehicle, in which a radiator grill is located in a conventional internal combustion engine vehicle. The environmental sensors 2 may sense the surrounding environment in different ways and enable autonomous driving of the vehicle based on the sensed results. As a non-limiting example, the environmental sensors 2 may include a LiDAR 4, a radar 6, and a camera 8. In addition, the environmental sensors 2 may further include an ultrasonic sensor, a radio frequency identification (RFID) sensor, or the like. The illustrated embodiment is an example, and the number of the environmental sensors 2 may be changed.

The front face of the vehicle is important in terms of vehicle design as it plays a dominant role in the aesthetics of the vehicle. In addition, since forward driving of the vehicle accounts for most of driving, the front part of the vehicle is bound to be frequently damaged by foreign substances flying during driving. It may be said that protection of environmental sensors on the front of the vehicle is essential to prepare for such damage or bad weather. A sensor cover 10 according to the present disclosure may satisfy both aesthetics and functionality, as will be described in more detail later.

Referring to FIG. 2, the sensor cover 10 according to the present disclosure may be mounted on the front face of the vehicle or the conventional radiator grill area G of the vehicle. As such, the sensor cover 10 may be mounted on the vehicle to protect the environmental sensors 2 located inside the sensor cover 10.

The sensor cover 10 may be provided with sensor regions for the respective environmental sensors 2. The sensor regions may include at least one of one or more LiDAR regions 14, one or more camera regions 16, or one or more radar regions 18, or some or all of these regions 14, 16, and 18. In one embodiment, the LiDAR regions 14 may overlap the LiDARs 4 to cover the LiDARs 4. In one embodiment, the camera region 16 may overlap the camera 8 to cover the camera 8. In one embodiment, the radar regions 18 may overlap the radar 6 to cover the radar 6. According to one embodiment of the present disclosure, the sensor cover 10 includes a structure for each sensor region 12, as will be described in more detail later.

The sensor cover 10 may also include a lighting region 20. The lighting region 20 may be provided on the sensor cover 10 in a range that does not influence the environmental sensors 2 or does not interfere with the environmental sensors 2. In one embodiment, the lighting region 20 may provide lighting using a hidden lighting method or an indirect lighting method.

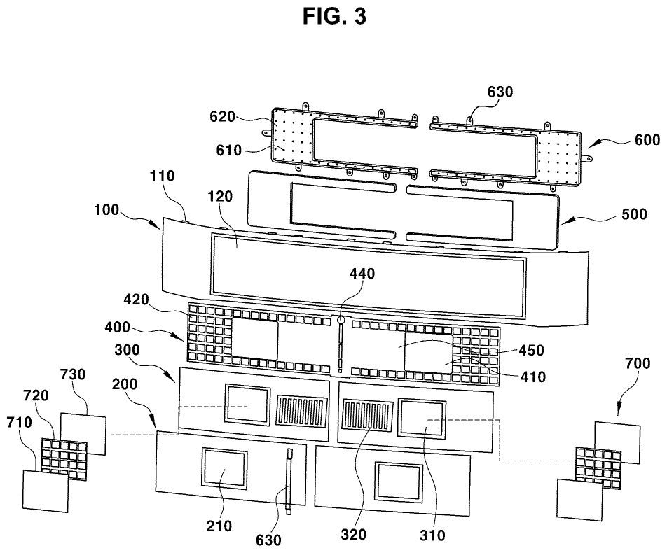

FIG. 3 is an exploded perspective view of the sensor cover 10 according to one embodiment of the present disclosure.

The sensor cover 10 may include a base 100. The base 100 may be directly connected to the vehicle. In one example, one or more connection parts 110 may be provided on the periphery of the base 100, and the base 100 may be mounted on the vehicle by the connection parts 110.

A window 120 is formed in the base 100. The window 120 is an opening of the base 100. Other parts of the sensor cover 10 may be inserted into the window 120 of the base 100 or may be supported by the base 100.

The sensor cover 10 includes a first layer 200 and a second layer 300. The first layer 200 and the second layer 300 are layers that contact with or are adjacent to the exterior of the vehicle and may be disposed on the outermost side of the sensor cover 10. In one example, the first layer 200 and the second layer 300 may be inserted into the window 120 of the base 100 to be supported by the base 100.

The first layer 200 and the second layer 300 may be formed of a material that does not impede the radio wave transmission performance of the environmental sensors 2. In one example, the first layer 200 and the second layer 300 may be formed of a transparent material. In some embodiments, the second layer 300 may be formed of polycarbonate (PC), and the first layer 200 may be formed of polyurethane (PU).

In one example, the first layer 200 and the second layer 300 may be integrally formed. In one embodiment, the first layer 200 may be formed on the surface of the second layer 300. For example, the second layer 300 formed of PC may be surface-treated with the first layer 200 formed of PU. The first layer 200 formed of PU is capable of self-healing. Specifically, if damage, such as scratches, occurs on the first layer 300 formed of PU, when the first layer 300 is exposed to a temperature of about 70° C. for 3 minutes, the first layer 300 may self-heal. Therefore, the sensor cover 10 according to the present disclosure may have a self-healing function through the first layer 200.

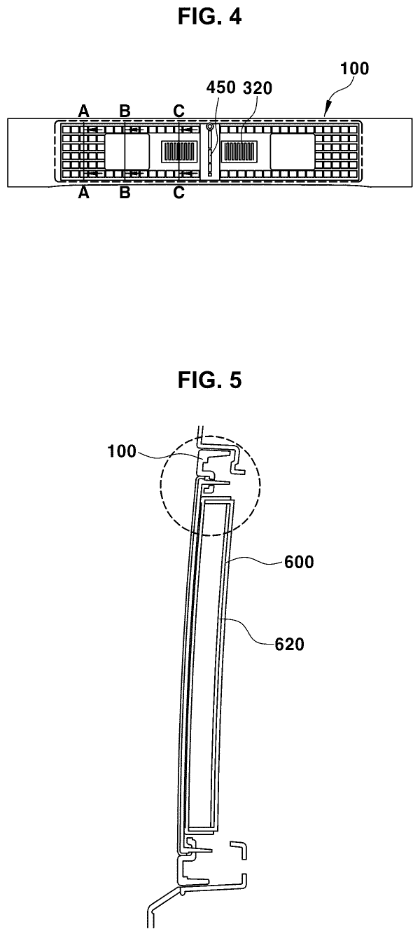

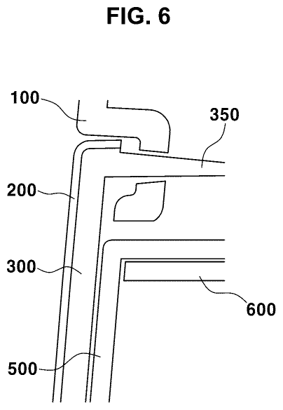

The first layer 200 and the second layer 300 may be formed through injection molding. As shown in FIG. 4, a region indicated by a dotted line represents a PU injection surface treated area. As shown in FIGS. 5 and 6, the first layer 200 may be formed on the surface of the second layer 300. The thickness of the first layer 200 may be smaller than the thickness of the second layer 300.

According to one embodiment of the present disclosure, the thickness of the first layer 200 may be 0.5 to 1.0 millimeter (mm). If the thickness of the first layer 200 is less than 0.5 mm, the second layer 300 may be damaged when concentrated chipping damage occurs. If the thickness of the first layer 200 exceeds 1.0 mm, the first layer 200 formed of PU becomes too thick, resulting in increase in material costs. In case of chipping where the first layer 200 is torn off, the first layer 200 may not self-heal despite the large thickness thereof.

According to the present disclosure, the second layer 300 including the first layer 200 may provide various advantages. Particularly, the first layer 200 having a thickness in the range of 0.5 to 1.0 mm may address external chipping or deep damage. Further, the first layer 200 formed of PU may be capable of self-healing from damage, such as scratches. In addition, as the uniform thickness and surface of the first layer 200 may be obtained through injection molding, the first layer 200 has an advantage of reducing a defect rate. Conventionally, the surface of a cover was protected through hard coating. However, the thickness of an obtained coating layer was small, which caused a defect rate in coating to be relatively high. However, according to the present disclosure, these problems that may occur in such a conventional hard coating layer may be solved.

Openings 310 are formed in the second layer 300. The LiDAR regions 14 may be formed in the openings 310. Further, the first layer 200 is formed on the surface of the second layer 300 such that openings 210 are formed in the first layer 200.

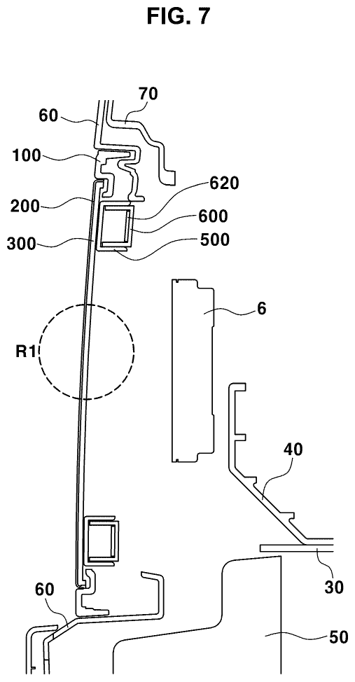

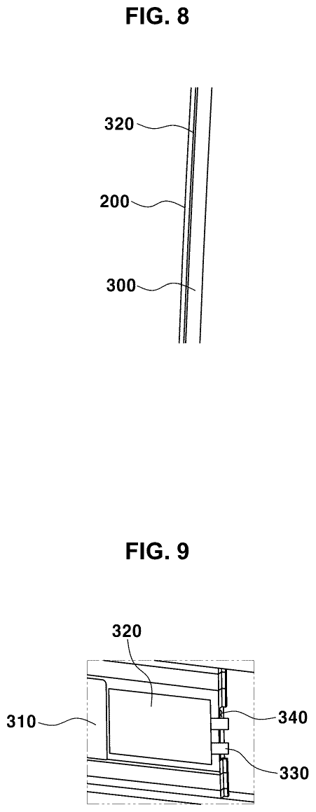

The second layer 300 may include a heating wire film 320. Referring to FIG. 7, the heating wire film 320 may be provided in the radar regions 18 to overlap the radar 6. In FIG. 7, the radar 6 may be fixed by a mounting bracket 40 fixed to a front back beam 30. Further, an energy absorber 50 is an impact mitigation part that fills a space between a bumper cover 60 and the front back beam 30 when a bumper is impacted and may be formed of Styrofoam. Reference numeral 70 represents a rigidity reinforcement bracket. Referring to FIG. 8, which is an enlarged view of region R1 of FIG. 7, the heating wire film 320 may be formed between the first layer 200 and the second layer 300.

The heating wire film 320 may maintain the transmission performance of the radar 6 even in a low-temperature environment or a harsh cold environment. In other words, the heating wire film 320 may improve the performance of the environmental sensors 2 by implementing defog and deice performance. Further, the heating wire film 320 may satisfy the radio wave transmission performance of the radar 6. According to the present disclosure, influence on the radio wave transmission may be minimized by arranging heating wires at predetermined intervals in the heating wire film 320. According to the present disclosure, in terms of design, exposure of the heating wire film 320 to the outside may be minimized, thereby being capable of providing improved aesthetics.

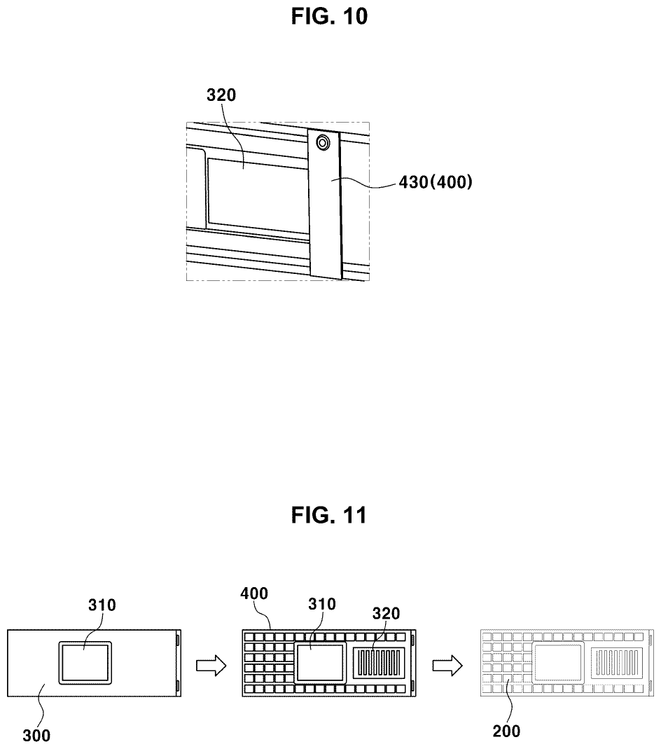

The heating wire film 320 is provided with one or more connectors 330. The connectors 330 may be connected to a controller 800 to control the heating wire film 320 and supply power to the heating wire film 320. As shown in FIG. 9, in some embodiments, the connectors 330 are formed in a depression 340 of the second layer 300. The depression 340 may be formed by depressing the side surface of the second layer 300. As shown in FIG. 10, this arrangement of the connectors 330 prevents the connectors 330 of the heating wire film 320 and wiring, which connects the connectors 330 to the controller 800, from being observed from the outside in relation to a panel 430 located in the center of a lighting film 400, thereby being capable of providing a clean appearance.

In some embodiments, the first layer 200, the second layer 300, and the heating wire film 320 may be manufactured through a process of FIG. 11. The second layer 300 having the openings 310 is arranged. For example, the second layer 300 may be formed of transparent PC and may be manufactured through injection molding. The heating wire film 320 may be adhered to the upper surface of the second layer 300. The lighting film 400 may be disposed on the rear side of the second layer 300 and may be observed from the upper surface of the second layer 300 through the transparent second layer 300. The first layer 200 may be formed on the second layer 300 to which the heating wire film 320 is adhered. For example, the first layer 200 may be formed on the surface of the second layer 300 through double injection molding using PU.

Referring again to FIG. 6, the second layer 300 may include a fastener 350. In one example, the second layer 300 may be mounted on the base 100 through the fastener 350.

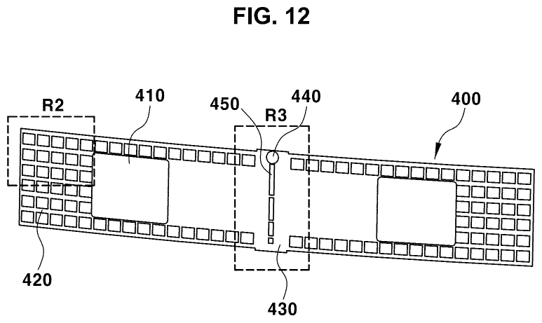

As shown in FIG. 12, the sensor cover 10 may further include the lighting film 400. The lighting film 400 is not configured to emit light on its own and may perform an indirect lighting function or a hidden lighting function.

A new image may be created during the day or in a bright place through the indirect lighting type lighting film 400. In addition, the lighting film 400 may transmit status information of the vehicle (for example, a turn signal function) and may transmit information for communicating with the outside.

Openings 410 may be formed in the lighting film 400. The openings 410 may be aligned with the openings 210 and 310.

The lighting film 400 may include a pattern structure 420. The pattern structure 420 may implement indirect lighting in various forms. The pattern structure 420 may be provided in the lighting film 400, particularly in a region of the lighting film 400 that do not interfere with the environmental sensors 2.

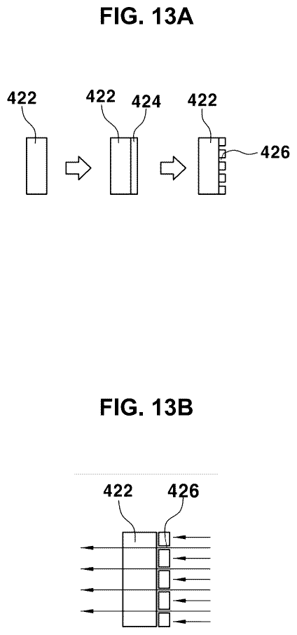

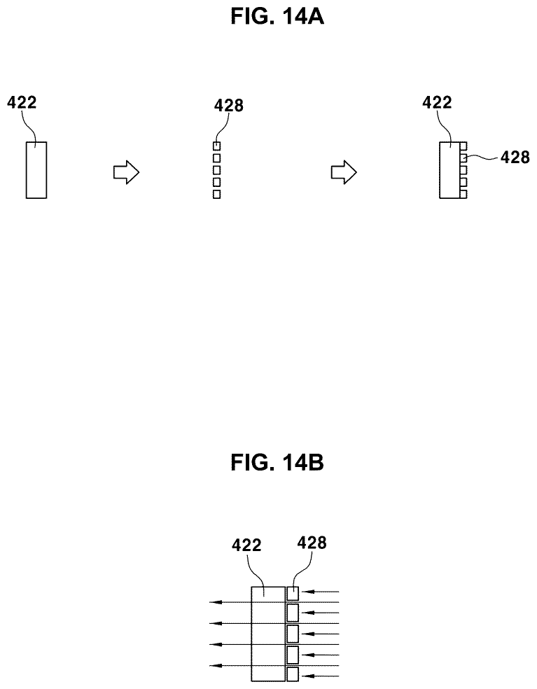

The pattern structure 420 may be formed by a laser perforation method or a film attachment method. As shown in FIGS. 13A and 13B, in the laser perforation method, a painted surface 424 is formed on a lens 422. The pattern structure 420 for hidden lighting may be obtained by forming a groove 426 through perforation of the painted surface 44 using a laser beam. As shown in FIGS. 14A and 14B, in the film attachment method, a pre-printed film 428 is attached to the lens 422. The pattern structure 420 for hidden lighting may be formed by allowing light to pass through a space between a pattern of the film 428. In some embodiments, a pattern structure 420 may be formed on one side (e.g., the left side) of the sensor cover 10 through the laser perforation method, and another pattern structure 420 may be formed on the other side (e.g., the right side) of the sensor cover 10 through the film attachment method. The laser perforation method may exhibit better quality, and the film attachment method may simplify a sensor cover manufacturing process. According to one embodiment of the present disclosure, the laser perforation method, the film attachment method, or a combination thereof may be appropriately used.

A diffusion layer 500 and a retaining plate 600 may be disposed on the rear or lower surface of the lighting film 400. The diffusion layer 500 may diffuse light supplied from LEDs 610 disposed on the retaining plate 600. A printed circuit board 620 on which a plurality of LEDs 610 are disposed may be mounted on the retaining plate 600. The plurality of LEDs 610 may be arranged at predetermined intervals on the printed circuit board 620. The plurality of LEDs 610 may be individually turned on and may be disposed to correspond to respective patterns of the pattern structure 420. This allows the lighting film 400 including the pattern structure 420 to be used as a unit for information transmission.

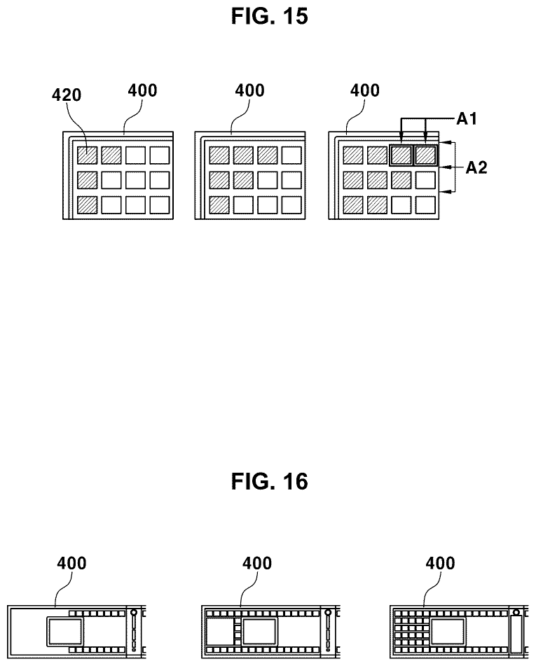

As shown in FIG. 15, the lighting film 400 includes a non-shielding region or a hidden lighting region A1 and a shielding black region A2. The pattern structure 420 at a desired position may emit indirect lighting depending on the control of the LEDs 610 disposed on the lower surface or in the rear of the lighting film 400. In the illustrated embodiment, the lighting film 400 may be used as an image expression or communication means through sequential lighting of the LEDs 610 from left to right.

FIG. 16 shows an example in which the lighting film 400 is used as an information transmission means. As welcome lighting, such as when a vehicle owner approaches the vehicle, control to sequentially turn on the LEDs 610 from the LED 610 at the center of the lighting film 400 to the LED 610 at the left of the lighting film 400 may be performed. In addition, through various controls of turning-on of the LEDs 610, goodbye lighting when the vehicle is turned off, turn signal light and emergency lights in conjunction with driving of the vehicle, etc., may be expressed. Further, turning-on of the LEDs 610 may be implemented through the lighting film 400 in conjunction with the temperature of the heating wire film 320, and various LED colors may be used. Moreover, lighting indicating the pitch of a sound in conjunction with music in the interior of the vehicle may be implemented. In one example, control that performs a notification function by flashing the LEDs 610 when an obstacle is detected may be performed.

The lighting film 400 may include the panel 430. The panel 430 may be provided at the center of the lighting film 400 and may be formed to protrude from other parts of the lighting film 400. As described above, the connectors 330 provided in the depression 340 of the heating wire film 320 are covered with the panel 430, thereby being capable of providing a clean appearance.

A hole 440 for the camera region 16 may be provided in the panel 430. The camera 8 may detect and image the surrounding environment of the vehicle through the hole 440.

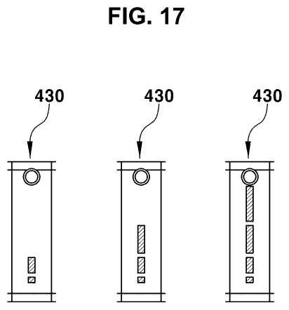

The panel 430 may further include a display 450. An LED module 630 capable of being turned on may be inserted into the display 450. As in an example shown in FIG. 17, the charging state of the electric vehicle may be displayed on the display 450 by driving the LED module 630.

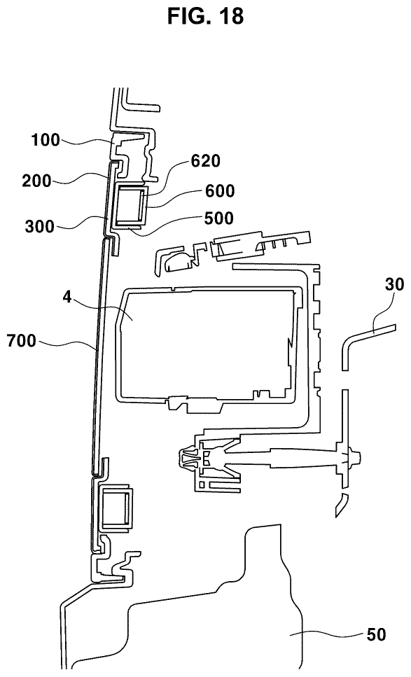

Referring to FIG. 18, as described below, the sensor cover 10 in the LiDAR regions 14 may be formed of a protective layer 700. In order to implement autonomous driving of vehicles, application of LiDARs, which may recognize objects at a greater distance than cameras, is becoming common. Due to the nature of LiDARs, when a LiDAR is blocked by an obstacle, the transmission performance of the LiDAR is limited. Therefore, the LiDAR is generally installed to be exposed to the outside of the vehicle. The present disclosure may provide a protection structure which does not cause external protrusion of the LiDARs 4 through surface treatment that does not damage infrared transmittance of the LiDARs 4.

The protective layer 700 may include a first protective layer 710, a coating layer 720, and a second protective layer 730. The first protective layer 710 and the second protective layer 730 may be manufactured in the same manner as the first layer 200 and the second layer 300. That is, the second protective layer 730 may be provided as a transparent PC layer, and the first protective layer 710 may be a transparent PU layer integrally formed with the second protective layer 730 or formed on the second protective layer 730 through surface treatment. The coating layer 720 may be disposed between the first protective layer 710 and the second protective layer 730. The coating layer 720 may be a polyethylene terephthalate (PET) film that may transmit infrared light. For example, the coating layer 720 may be a PICASUS® film.

According to the present disclosure, operation of the sensor cover 10 may be controlled by one or more controllers 800. For each component of the sensor cover 10, one or more controllers 800 may be involved in controlling each component. Alternatively, one or more controllers 800 may control the components of the sensor cover 10. In one example, the controller 800 may control driving of the LEDs 610 through the printed circuit board 620. The controller 800 may control driving of each LED 610 depending on a predetermined lighting pattern.

In one example, the controller 800 may control operation of the heating wire film 320. In one example, the controller 800 may supply power to the heating wires of the heating wire film 320. In one example, the controller 800 may operate the heating wire film 320 at a point in time when it is necessary to raise the temperature. In one example, the controller 800 may limit operation of the heating wire film 320 to prevent excessive heat generation from the heating wiring film 320.

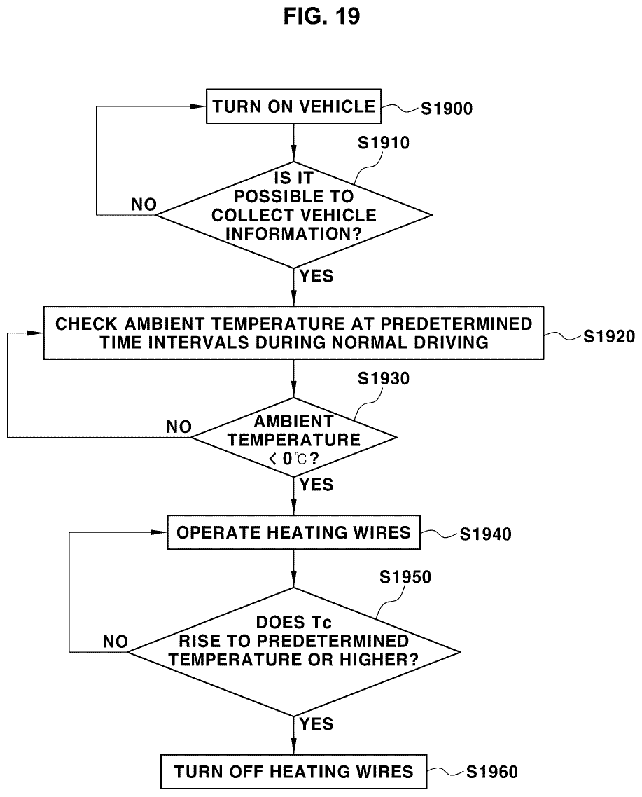

As shown in FIG. 19, the vehicle is started at Operation S1900. The controller 800 determines whether starting of the vehicle is maintained and thus it is possible to collect vehicle information at Operation S1910. If it is not possible to collect the vehicle information, the controller 800 returns to Operation S1900, and if it is possible to collect the vehicle information, the controller 800 checks ambient temperature information at predetermined time intervals during normal driving at Operation S1920. The controller 800 is configured to communicate with an ambient temperature sensor 810 of the vehicle to collect the vehicle information. Further, the controller 800 may collect the surface temperature information of the sensor cover 10 to collect the vehicle information.

The controller 800 determines continuously or in real time whether an ambient temperature is lower than 0° C. based on the received ambient temperature information at Operation S1930. If the ambient temperature is 0° C. or higher, the controller 800 returns to Operation S1920. On the other hand, if the ambient temperature is lower than 0° C., the controller 800 operates the heating wires of the heating wire film 320 at Operation S1940. The operating time and shutdown time of the heating wires may be predetermined. For example, the heating wires may be operated for 10 minutes, and operation of the heating wires may be stopped for 3 minutes in one operating cycle.

While the heating wires are operated, the controller 800 determines whether the surface temperature Tc of the sensor cover 10 rises to a predetermined temperature or higher at Operation S1950. As a non-limiting example, the predetermined temperature may be 5° C.

In response to determining that the surface temperature Tc of the sensor cover 10 does not rise to the predetermined temperature Tc or higher, the controller 800 returns to Operation S1940 and operates the heating wires. On the other hand, in response to determining that the surface temperature Tc of the sensor cover 10 rises to the predetermined temperature or higher, the controller 800 stops operation of the heating wires at operation S1960.

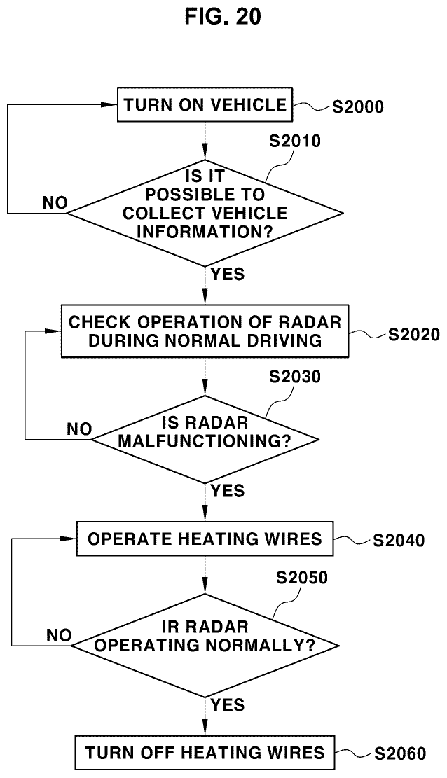

As shown in FIG. 20, according to some embodiments of the present disclosure, the vehicle is started at Operation S2000. The controller 800 determines whether starting of the vehicle is maintained and thus it is possible to collect vehicle information at Operation S2010). If it is not possible to collect the vehicle information, the controller 800 returns to Operation S2000. If it is possible to collect the vehicle information, the controller 800 determines whether the radar 6 is operating normally during normal driving at Operation S2020. The controller 800 is configured to communicate with the radar 6 to collect the vehicle information, thereby being capable of collecting the vehicle information.

The controller 800 determines whether the radar 6 is malfunctioning based on the operation information of the radar 6 at Operation S2030. Particularly, the controller 800 may determine whether the radar 6 is malfunctioning due to freezing based on the operation information of the radar 6.

If it is determined that the radar 6 is malfunctioning due to surface freezing, the controller 800 operates the heating wires of the heating wire film 320 at Operation S2040. The operating time and shutdown time of the heating wires may be predetermined. For example, the heating wires may be operated for 10 minutes, and operation of the heating wires may be stopped for 3 minutes in one operating cycle.

While the heating wires are operated, the controller 800 determines whether the radar 6 is operating normally by collecting the operation information of the radar 6 in real time at Operation S2050. Upon determining that the radar 6 is normally operating, the controller 800 stops operation of the heating wires. On the other hand, upon determining that the radar 6 is still malfunctioning due to surface freezing, the controller 800 continues to operate the heating wires at Operation S2060.

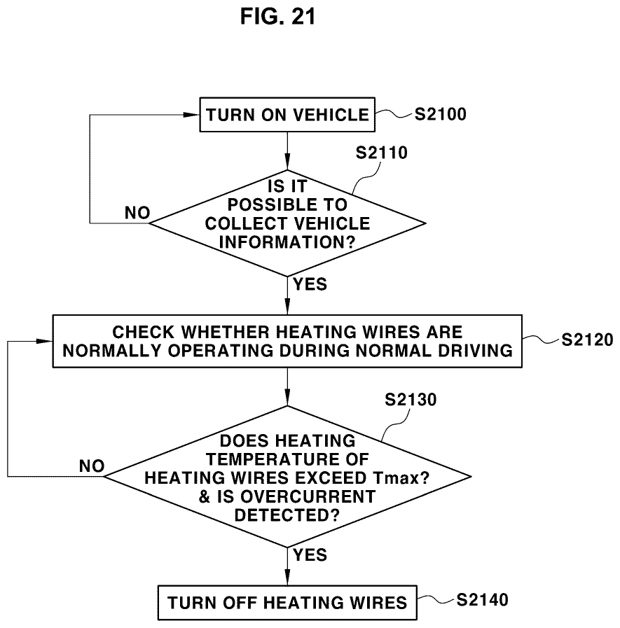

As shown in FIG. 21, according to some embodiments of the present disclosure, the vehicle is started at Operation S2100.

The controller 800 determines whether starting of the vehicle is maintained and thus it is possible to collect vehicle information at S2110. If it is not possible to collect the vehicle information, the controller 800 returns to Operation S2100. If it is possible to collect the vehicle information, the controller 800 determines whether the heating wires of the heating wire film 320 are normally operating during normal driving at Operation S2120. The controller 800 is configured to communicate with the heating wires or the heating wire film 320 to collect the vehicle information, thereby being capable of determining whether the heating wires are normally operating.

The controller 800 determines whether the heating temperature of the heating wires exceeds a threshold temperature Tmax and/or whether overcurrent is detected based on received operation information of the heating wires at Operation S2130.

If the heating temperature of the heating wires exceeds the threshold temperature Tmax or if overcurrent is detected, the controller 800 stops operation of the heating wires of the heating wire film 320 at Operation S2140. Accordingly, according to the present disclosure, the heating wire film 320 may be configured to only generate heat at a set temperature or lower, thereby being capable of ensuring safety.

The sensor cover 10 according to the present disclosure may be applied to various vehicle types, such as sedans, sport utility vehicles (SUVs), trucks, and buses.

The sensor cover 10 according to the present disclosure uses PC materials, which are eco-friendly plastics, and thus is eco-friendly and may satisfy required environmental laws and regulations.

As is apparent from the above description, the present disclosure provides a sensor cover which may protect environmental sensors of a vehicle.

The present disclosure provides a sensor cover which does not hinder the transmission performance of environmental sensors.

The present disclosure provides a sensor cover which may improve the aesthetics.

The present disclosure provides a sensor cover which may prevent deterioration of the functions of environmental sensors even when the external environment worsens.

The effects of the present disclosure are not limited to the above-mentioned effects, and other effects not mentioned herein will be clearly understood by those skilled in the art from the above description.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A sensor cover configured to transmit detection signals of different environmental sensors and comprising a plurality of sensing regions provided for each of the different environmental sensors.

2. The sensor cover of claim 1, further comprising a first layer and a second layer, wherein the second layer is formed of a transparent material, and wherein the first layer is formed of a transparent material and is surface-treated on a first face of the second layer.

3. The sensor cover of claim 2, wherein the first layer is formed of polyurethane, and the second layer is formed of polycarbonate.

4. The sensor cover of claim 2, wherein the first layer is integrally formed with the second layer.

5. The sensor cover of claim 2, further comprising:
a lighting film disposed on a second face of the second layer and comprising one or more pattern structures; and
a plurality of light emitting diodes (LEDs) configured to supply light through each pattern structure, turning-on of the plurality of LEDs and being individually controllable.

6. The sensor cover of claim 5, wherein each pattern structure comprises:
one or more shielding regions configured to block light from the plurality of LEDs; and
one or more non-shielding regions configured to transmit the light from the plurality of LEDs.

7. The sensor cover of claim 5, further comprising a diffusion layer disposed between the lighting film and the plurality of LEDs.

8. The sensor cover of claim 5, wherein an LED module comprising the plurality of LEDs configured to be individually turned on is disposed at a center portion of the lighting film.

9. The sensor cover of claim 2, wherein a heating wire film is disposed between the first layer and the second layer, and wherein operation of the heating wire film is controllable.

10. The sensor cover of claim 1, wherein the plurality of sensing regions comprises:
a LiDAR region configured to transmit a detection signal from a LiDAR installed in a vehicle; and
a radar region configured to transmit a detection signal from a radar installed in the vehicle.

11. The sensor cover of claim 10, wherein a protective layer capable of transmitting infrared light from the LiDAR is disposed in the LiDAR region.

12. The sensor cover of claim 11, wherein the protective layer comprises a coating layer formed of polyethylene terephthalate (PET) capable of transmitting infrared light.

13. The sensor cover of claim 12, wherein the LiDAR region comprises:
a first protective layer disposed on a first side of the coating layer; and
a second protective layer disposed on a second side of the coating layer;
wherein the first protective layer is formed of polyurethane, and the second protective layer is formed of polycarbonate.

14. The sensor cover of claim 13, wherein the first protective layer is fixed to the second protective layer through injection molding, and the first protective layer is formed on the second protective layer and the coating layer through injection molding.

15. The sensor cover of claim 10, wherein a heating wire film controllable by a controller is disposed in the LiDAR region.

16. The sensor cover of claim 15, wherein the controller is configured, during driving of the vehicle, to:
control an operation of the heating wire film based on ambient temperature information;
control the operation of the heating wire film based on whether the LiDAR is operated; or
control the operation of the heating wire film based on a heating temperature of the heating wire film.

17. The sensor cover of claim 10, wherein the plurality of sensing regions further comprises a camera region configured to transmit a detection signal from a camera.

18. The sensor cover of claim 1, wherein the environmental sensors comprise at least some of a LiDAR, a radar, or a camera.
